(19) United States
(12) Patent Application Publication
(10) Pub. No.: US 2025/0309652 A1
(43) Pub. Date: Oct. 2, 2025

(54) POWER SUPPLY SYSTEM, MOVING OBJECT, AND METHOD OF CONTROLLING POWER SUPPLY SYSTEM

(71) Applicant: HONDA MOTOR CO., LTD., Tokyo (JP)

(72) Inventor: Takeshi Matsumoto, Wako-shi (JP)

(21) Appl. No.: 19/084,607

(22) Filed: Mar. 19, 2025

(30) Foreign Application Priority Data
Mar. 27, 2024 (JP) 2024-051976

(51) Int. Cl. H02J 3/32; B64D 31/18; H02J 3/38

(52) U.S. Cl. CPC H02J 3/32; B64D 31/18; H02J 3/38; B64D 2221/00; H02J 2300/10; H02J 2310/44

(57) ABSTRACT

In an electrical power supply system, a battery controller provides a flight controller with capability information including first information and second information, the first information indicating an upper limit of electrical power that can be input and output by a battery continuously for a first period, the second information indicating an upper limit of electrical power that can be input and output by the battery continuously for a second period. The flight controller controls a VTOL electric motor and a cruise electric motor, based on the capability information.

### CROSS-REFERENCE TO RELATED APPLICATIONS

This application is based upon and claims the benefit of priority from Japanese Patent Application No. 2024-051976 filed on Mar. 27, 2024, the contents of which are incorporated herein by reference.

### BACKGROUND OF THE INVENTION

### Field of the Invention

The present disclosure relates to an electrical power supply system, a moving object, and a method of controlling an electrical power supply system.

### DESCRIPTION OF THE RELATED ART

JP 2020-075649 A discloses a flying object having a battery and a generator driven by a gas turbine engine, as power sources for an electric motor.

### SUMMARY OF THE INVENTION

There is a demand for a more satisfactory electrical power supply system, a more satisfactory moving object, and a method of more satisfactorily controlling such an electrical power supply system.

The present invention has the object of solving the aforementioned problem.

A first aspect of the present disclosure is characterized by an electrical power supply system including a first generator configured to be driven by a first gas turbine engine to generate electrical power, a first power control unit configured to convert an alternating current electrical power output from the first generator into a direct current electrical power, a first electrical power supply circuit configured to supply an output electrical power of the first power control unit to a first load device, a first battery connected in parallel with the first power control unit, a load controller configured to control the first load device, and a battery controller configured to manage the first battery, wherein the battery controller provides the load controller with capability information including first information and second information, the first information indicating an upper limit of electrical power that is capable of being input and output by the first battery continuously for a first period, the second information indicating an upper limit of electrical power that is capable of being input and output by the first battery continuously for a second period longer than the first period, and the load controller controls the first load device, based on the capability information provided by the battery controller.

A second aspect of the present disclosure is characterized by a moving object including the electrical power supply system according to the first aspect.

A third aspect of the present disclosure is characterized by a method of controlling an electrical power supply system including a first generator configured to be driven by a first gas turbine engine to generate electrical power, a first power control unit configured to convert an alternating current electrical power output from the first generator into a direct current electrical power, a first electrical power supply circuit configured to supply an output electrical power of the first power control unit to a first load device, a first battery connected in parallel with the first power control unit, a load controller configured to control the first load device, and a battery controller configured to manage the first battery, the method including providing the load controller with capability information including first information and second information, from the battery controller, the first information indicating an upper limit of electrical power that is capable of being input and output by the first battery continuously for a first period, the second information indicating an upper limit of electrical power that is capable of being input and output by the first battery continuously for a second period longer than the first period, and controlling the first load device by the load controller, based on the capability information provided from the battery controller.

According to the present disclosure, it is possible to provide a more satisfactory electrical power supply system, a more satisfactory moving object, and a method of more satisfactorily controlling such an electrical power supply system.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram of a moving object according to one embodiment;

FIG. 2 is a schematic diagram illustrating an electrical system configuration of an electrical power supply system according to the one embodiment;

FIG. 3 is a schematic diagram illustrating a control system configuration of the electrical power supply system according to the one embodiment;

FIG. 4 is a graph illustrating changes over time of an upper limit value and a lower limit value of output electrical power of each of a first electrical power generating device and a second electrical power generating device;

FIG. 5 is a map illustrating an upper limit value of the output electrical power and the upper limit value of the input electrical power of a battery of each of a first electrical power storage device, a second electrical power storage device, a third electrical power storage device, and a fourth electrical power storage device;

FIG. 6 is a flowchart of a command value determination control executed in a management controller and a flight controller;

FIG. 7 is a flowchart of an output power mediation process; and

FIG. 8 is a flowchart of the output power mediation process.

### DETAILED DESCRIPTION OF THE INVENTION

Conventionally, an electrical power supply system, which is equipped with two electrical power sources including an electrical power generating device and a battery, has been proposed as an electrical power supply system that is mounted on an electric vertical take-off and landing aircraft (eVTOL aircraft). An electric motor for driving each of rotors of the eVTOL aircraft is driven by electrical power supplied from the electrical power generating device and electrical power supplied from the battery.

An electrical power generating device includes a gas turbine engine, a generator driven by the gas turbine engine, and a power control unit for converting the three-phase AC electrical power output from the generator into the DC electrical power. In the case that required electrical power of each of the electric motors increases or decreases, the output electrical power of the electrical power generating device is increased or decreased by increasing or decreasing the output power of the gas turbine engine. However, since the time responsiveness of the output power of the gas turbine engine is relatively low, the increase or decrease in the output electrical power of the electrical power generating device may not be able to follow the increase or decrease in the required electrical power of each of the electric motors.

Therefore, in the case that the required electrical power of each of the electric motors increases and the output electrical power of the electrical power generating device is insufficient, the output electrical power of the battery is supplied to each of the electric motors in addition to the output electrical power of the electrical power generating device. Further, in the case that the required electrical power of each of the electric motors decreases and the output electrical power of the electrical power generating device becomes surplus, a part of the output electrical power of the electrical power generating device is stored in the battery.

However, since the amount of electrical power (the electrical energy) charged to or discharged by the battery is limited, in the case that the battery is charged or discharged in accordance with the required electrical power of each of the electric motors, there is a possibility that overdischarge or overcharge of the battery occurs. The electrical power supply system of the present disclosure can suppress overcharge and overdischarge of a battery.

### Embodiments

### Configuration of Moving Object

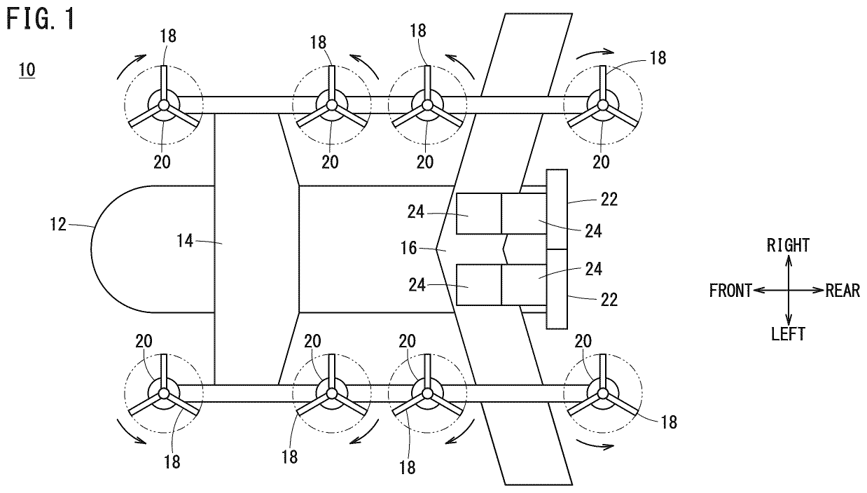

FIG. 1 is a schematic diagram of a moving object 10 according to one embodiment. The moving object 10 of the one embodiment is an electric vertical take-off and landing aircraft (eVTOL aircraft). The moving object 10 has a fuselage 12. The fuselage 12 is provided with a cockpit, a cabin, and the like. A pilot is in the cockpit and controls the moving object 10. The cabin is used for passengers and others. The moving object 10 may be automatically piloted.

The moving object 10 has a front wing 14 and a rear wing 16. In the case that the moving object 10 moves forward, each of the front wing 14 and the rear wing 16 generates lift.

The moving object 10 is equipped with eight VTOL rotors 18. One VTOL electric motor 20 is provided for one VTOL rotor 18. The moving object 10 includes two cruise rotors 22. Two cruise electric motors 24 are provided for one cruise rotor 22.

### Configuration of Electrical Power Supply System

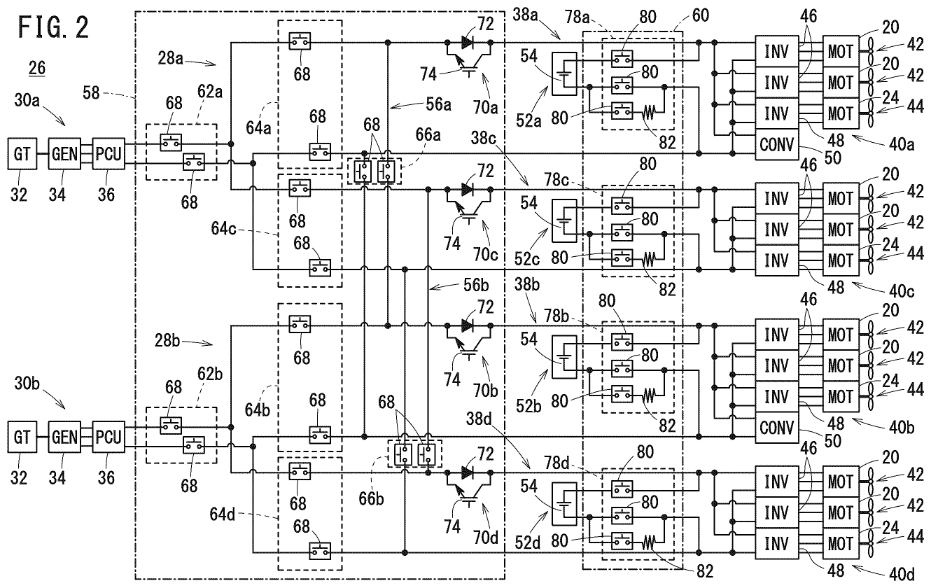

FIG. 2 is a schematic diagram illustrating an electrical system configuration of an electrical power supply system 26 according to the one embodiment. The electrical power supply system 26 is equipped with two electrical power supply subsystems including a first electrical power supply subsystem 28a and a second electrical power supply subsystem 28b. The electrical power supply system 26 includes a first electrical power generating device 30a that is a main electrical power source of the first electrical power supply subsystem 28a. The electrical power supply system 26 includes a second electrical power generating device 30b that is a main electrical power source of the second electrical power supply subsystem 28b.

Each of the first electrical power generating device 30a and the second electrical power generating device 30b includes a gas turbine engine 32, a generator 34, and a power control unit (hereinafter referred to as PCU) 36. The gas turbine engine 32 drives the generator 34. As a result, the generator 34 generates electrical power. The PCU 36 converts the AC electrical power generated by the generator 34 into DC electrical power and outputs the DC electrical power. In the case that the gas turbine engine 32 is started, the PCU 36 converts the DC electrical power input to the PCU 36 into AC electrical power and outputs the AC electrical power to the generator 34. The generator 34 is operated by the AC electrical power, and the generator 34 drives the gas turbine engine 32.

The gas turbine engine 32 of the first electrical power generating device 30a corresponds to a first gas turbine engine of the present invention. The generator 34 of the first electrical power generating device 30a corresponds to a first generator of the present invention. The PCU 36 of the first electrical power generating device 30a corresponds to a first power control unit of the present invention. The gas turbine engine 32 of the second electrical power generating device 30b corresponds to a second gas turbine engine of the present invention. The generator 34 of the second electrical power generating device 30b corresponds to a second generator of the present invention. The PCU 36 of the second electrical power generating device 30b corresponds to a second power control unit of the present invention.

The first electrical power generating device 30a and the second electrical power generating device 30b may also include various sensors such as a voltage sensor and a current sensor, and various elements such as fuses, relays, breakers, diodes, transistors, resistors, coils, capacitors, or the like.

The electrical power supply system 26 includes a first electrical power supply circuit 38a, a second electrical power supply circuit 38b, a third electrical power supply circuit 38c, and a fourth electrical power supply circuit 38d.

The first electrical power supply circuit 38a supplies a DC electrical power output from the first electrical power generating device 30a to a first load module 40a. The second electrical power supply circuit 38b supplies a DC electrical power output from the second electrical power generating device 30b to a second load module 40b. The third electrical power supply circuit 38c supplies a DC electrical power output from the first electrical power generating device 30a to a third load module 40c. The fourth electrical power supply circuit 38d supplies a DC electrical power output from the second electrical power generating device 30b to a fourth load module 40d.

Each of the first load module 40a, the second load module 40b, the third load module 40c, and the fourth load module 40d has two VTOL drive devices 42 and one cruise drive device 44. Each of the VTOL drive devices 42 includes an inverter 46 and the VTOL electric motor 20. The inverter 46 converts the DC electrical power input to the inverter 46 into three phase AC electrical power and outputs the AC electrical power to the VTOL electric motor 20.

Each of the cruise drive devices 44 includes an inverter 48 and a cruise electric motor 24. The inverter 48 converts the DC electrical power input to the inverter 48 into three phase AC electrical power and outputs the AC electrical power to the cruise electric motor 24.

Each of the first load module 40a and the second load module 40b has a DC-DC converter 50. The DC-DC converter 50 steps down the voltage of the DC electrical power input to the DC-DC converter 50 and outputs the power to equipment operated by DC electrical power. The equipment operated by DC electrical power includes, for example, a cooling device for cooling the PCU 36, the inverter 46, the inverter 48, and the like.

The first load module 40a, the second load module 40b, the third load module 40c, and the fourth load module 40d may also include various sensors such as voltage sensors and current sensors or the like, and various elements such as fuses, relays, breakers, diodes, transistors, resistors, coils, capacitors, or the like.

Each of the VTOL electric motors 20 and the cruise electric motor 24 of the first load module 40a corresponds to a first load device of the present invention. Each of the VTOL electric motors 20 and the cruise electric motor 24 of the second load module 40b corresponds to a second load device of the present invention.

A first electrical power storage device 52a is connected to the first electrical power supply circuit 38a. A second electrical power storage device 52b is connected to the second electrical power supply circuit 38b. A third electrical power storage device 52c is connected to the third electrical power supply circuit 38c. A fourth electrical power storage device 52d is connected to the fourth electrical power supply circuit 38d.

The first electrical power storage device 52a, the second electrical power storage device 52b, the third electrical power storage device 52c, and the fourth electrical power storage device 52d each include a battery 54. The battery 54 is, for example, a lithium ion battery. The battery 54 of the first electrical power storage device 52a corresponds to a first battery of the present invention. The battery 54 of the second electrical power storage device 52b corresponds to a second battery of the present invention.

The first electrical power storage device 52a, the second electrical power storage device 52b, the third electrical power storage device 52c, and the fourth electrical power storage device 52d may each include various sensors such as voltage sensors and current sensors or the like, and various elements such as fuses, relays, breakers, diodes, transistors, resistors, coils, capacitors, or the like.

The first electrical power supply circuit 38a and the second electrical power supply circuit 38b are connected by a first connection circuit 56a. The third electrical power supply circuit 38c and the fourth electrical power supply circuit 38d are connected by a second connection circuit 56b.

The electrical power supply system 26 includes a main junction box 58 and a battery junction box 60.

The main junction box 58 has a first disconnection device 62a and a second disconnection device 62b. The first disconnection device 62a is capable of disconnecting the first electrical power generating device 30a from the first electrical power supply circuit 38a and the third electrical power supply circuit 38c. The second disconnection device 62b is capable of disconnecting the second electrical power generating device 30b from the second electrical power supply circuit 38b and the fourth electrical power supply circuit 38d.

The main junction box 58 has a third disconnection device 64a, a fourth disconnection device 64b, a fifth disconnection device 64c, and a sixth disconnection device 64d. The third disconnection device 64a is capable of disconnecting the first electrical power generating device 30a from the first electrical power supply circuit 38a. The fourth disconnection device 64b is capable of disconnecting the second electrical power generating device 30b from the second electrical power supply circuit 38b. The fifth disconnection device 64c is capable of disconnecting the first electrical power generating device 30a from the third electrical power supply circuit 38c. The sixth disconnection device 64d is capable of disconnecting the second electrical power generating device 30b from the fourth electrical power supply circuit 38d.

The main junction box 58 has a first connection device 66a and a second connection device 66b. The first connection device 66a is capable of connecting the first electrical power supply circuit 38a and the second electrical power supply circuit 38b via the first connection circuit 56a. The second connection device 66b is capable of connecting the third electrical power supply circuit 38c and the fourth electrical power supply circuit 38d via the second connection circuit 56b.

The first disconnection device 62a, the second disconnection device 62b, the third disconnection device 64a, the fourth disconnection device 64b, the fifth disconnection device 64c, the sixth disconnection device 64d, the first connection device 66a, and the second connection device 66b each has two contactors 68. One of the contactors 68 is provided in the wiring of a positive electrode, and another of the contactors 68 is provided in the wiring of a negative electrode.

The main junction box 58 has a first reverse current prevention device 70a, a second reverse current prevention device 70b, a third reverse current prevention device 70c, and a fourth reverse current prevention device 70d. The first reverse current prevention device 70a, the second reverse current prevention device 70b, the third reverse current prevention device 70c, and the fourth reverse current prevention device 70d each include a diode 72 and an insulated gate bipolar transistor (referred to as IGBT hereinafter) 74. In the case that the IGBT 74 is OFF, the diode 72 prevents the reverse current in each of the first electrical power supply circuit 38a, the second electrical power supply circuit 38b, the third electrical power supply circuit 38c, and the fourth electrical power supply circuit 38d. In the case that the IGBT 74 is ON, the reverse current is allowed, bypassing the diode 72, in each of the first electrical power supply circuit 38a, the second electrical power supply circuit 38b, the third electrical power supply circuit 38c, and the fourth electrical power supply circuit 38d.

The battery junction box 60 has a seventh disconnection device 78a, an eighth disconnection device 78b, a ninth disconnection device 78c, and a tenth disconnection device 78d. The seventh disconnection device 78a, the eighth disconnection device 78b, the ninth disconnection device 78c, and the tenth disconnection device 78d each include three contactors 80 and a precharge resistor 82. One of the three contactors 80 is provided in the wiring of the positive electrode. Another of the three contactors 80 is provided in the wiring of the negative electrode. Still another one of the three contactors 80 is provided in a precharge circuit that bypasses the contactor 80 provided in the negative electrode. The precharge resistor 82 is provided in the precharge circuit in series with the contactor 80.

The seventh disconnection device 78a is capable of disconnecting the first electrical power storage device 52a from the first electrical power supply circuit 38a. The eighth disconnection device 78b is capable of disconnecting the second electrical power storage device 52b from the second electrical power supply circuit 38b. The ninth disconnection device 78c is capable of disconnecting the third electrical power storage device 52c from the third electrical power supply circuit 38c. The tenth disconnection device 78d is capable of disconnecting the fourth electrical power storage device 52d from the fourth electrical power supply circuit 38d.

In the case that the first electrical power generating device 30a and the first load module 40a are precharged by the DC electrical power of the first electrical power storage device 52a, the seventh disconnection device 78a outputs the DC electrical power from the first electrical power storage device 52a to the first electrical power supply circuit 38a through the precharge circuit. In the case that the second electrical power generating device 30b and the second load module 40b are precharged by the DC electrical power of the second electrical power storage device 52b, the eighth disconnection device 78b outputs the DC electrical power from the second electrical power storage device 52b to the second electrical power supply circuit 38b through the precharge circuit. In the case that the first electrical power generating device 30a and the third load module 40c are precharged by the DC electrical power of the third electrical power storage device 52c, the ninth disconnection device 78c outputs the DC electrical power from the third electrical power storage device 52c to the third electrical power supply circuit 38c through the precharge circuit. In the case that the second electrical power generating device 30b and the fourth load module 40d are precharged by the DC electrical power of the fourth electrical power storage device 52d, the tenth disconnection device 78d outputs the DC electrical power from the fourth electrical power storage device 52d to the fourth electrical power supply circuit 38d through the precharge circuit.

### Configuration of Control System

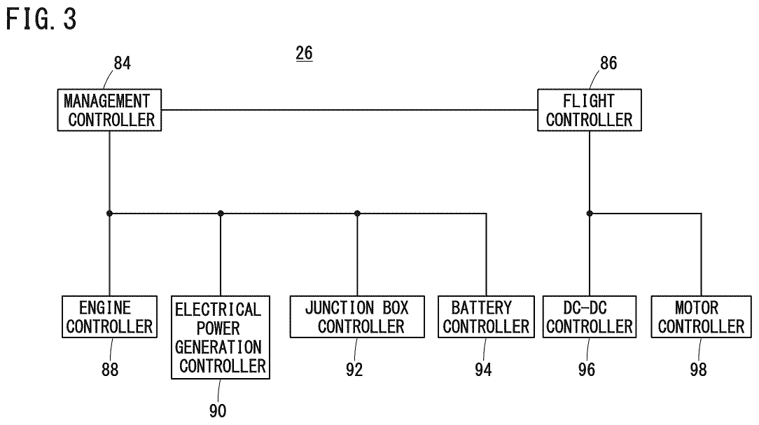

FIG. 3 is a schematic diagram illustrating a control system configuration of the electrical power supply system 26 according to the one embodiment. The electrical power supply system 26 in the one embodiment includes a management controller 84, a flight controller 86, an engine controller 88, an electrical power generation controller 90, a junction box controller 92, a battery controller 94, a DC-DC controller 96, and a motor controller 98.

The management controller 84, the flight controller 86, the engine controller 88, the electrical power generation controller 90, the junction box controller 92, the battery controller 94, the DC-DC controller 96, and the motor controller 98 each transmit and receive signals through control area network communications.

The management controller 84, the flight controller 86, the engine controller 88, the electrical power generation controller 90, the junction box controller 92, the battery controller 94, the DC-DC controller 96, and the motor controller 98 each have a computation unit and a storage unit (neither of which is shown).

The computation unit is, for example, a processor such as a central processing unit (CPU) or a graphics processing unit (GPU). The computation unit controls each of the devices by executing a program that is stored in the storage unit. At least a portion of the computation unit may be realized by an integrated circuit such as an ASIC (Application Specific Integrated Circuit) or an FPGA (Field-Programmable Gate Array) or the like. At least a portion of the computation unit may be realized by an electronic circuit including a discrete device.

The storage unit is constituted by a volatile memory and a non-volatile memory, which are computer-readable storage media. The volatile memory, for example, is a RAM (Random Access Memory) or the like. The non-volatile memory, for example, is a ROM (Read Only Memory), a flash memory, or the like. Data and the like are stored in, for example, the volatile memory. Programs, tables, maps, and the like are stored, for example, in the non-volatile memory. At least part of the storage unit may be included in the processor, the integrated circuit, or the like described above.

The management controller 84 manages the electrical power supplied to each of the first load module 40a, the second load module 40b, the third load module 40c, and the fourth load module 40d. The flight controller 86 manages the operations of each of the first load module 40a, the second load module 40b, the third load module 40c, and the fourth load module 40d. The flight controller 86 corresponds to a load controller of the present invention.

The engine controller 88 controls the rotational speed and torque of the gas turbine engine 32 based on the information sent from the management controller 84. The engine controller 88 monitors the state of the gas turbine engine 32, such as the rotational speed and torque, and transmits information indicating the state of the gas turbine engine 32 to the management controller 84.

The electrical power generation controller 90 controls the rotational speed and torque of the generator 34 based on the information sent from the management controller 84. The electrical power generation controller 90 monitors the state of the generator 34, such as the rotational speed and torque, and transmits information indicating the state of the generator 34 to the management controller 84.

The junction box controller 92 controls the main junction box 58 based on the information sent from the management controller 84. The junction box controller 92 controls ON/OFF of each of the contactors 68 in the main junction box 58, and controls ON/OFF of each of the IGBTs 74. The junction box controller 92 monitors the state of each of the contactors 68 and the state of each of the IGBTs 74 of the main junction box 58, and sends information indicating the state of the main junction box 58 to the management controller 84.

The battery controller 94 controls the battery junction box 60 based on the information sent from the management controller 84. The battery controller 94 controls ON/OFF of each of the contactors 80 in the battery junction box 60. The battery controller 94 monitors the state of the battery 54 and the battery junction box 60 and sends information indicative of the state of the battery 54 and the battery junction box 60 to the management controller 84. The battery controller 94 transmits information such as the SOC (State Of Charge) of the battery 54, the upper limit value of the output electrical power of the battery 54, and the upper limit value of the input electrical power of the battery 54 to the management controller 84 as the state of the battery 54. The battery controller 94 sends information such as the ON/OFF state of each of the contactors 80 to the management controller 84 as the state of the battery junction box 60.

The DC-DC controller 96 controls the DC-DC converter 50 based on the information sent from the flight controller 86. The motor controller 98 controls each of the VTOL drive devices 42 and each of the cruise drive devices 44 based on the information transmitted from the flight controller 86.

### Estimation of Output Electrical Power of Electrical Power Generating Device

In the electrical power supply system 26 of the one embodiment, the output electrical power of the first electrical power generating device 30a is increased or decreased in accordance with the increase or decrease in the required electrical power of the first load module 40a and the required electrical power of the third load module 40c. Similarly, in the electrical power supply system 26 of the one embodiment, the output electrical power of the second electrical power generating device 30b is increased or decreased in accordance with the increase or decrease in the required electrical power generating device power of the second load module 40b and the required electrical power of the fourth load module 40d.

In the case that the output electrical power of the first electrical power generating device 30a and the output electrical power of the second electrical power generating device 30b are increased or decreased, the output power of the gas turbine engine 32 is increased or decreased. However, since the time responsiveness of the output power of the gas turbine engine 32 is relatively low, it takes time to increase or decrease the output electrical power of the first electrical power generating device 30a and the output electrical power of the second electrical power generating device 30b.

The flight controller 86 can adjust the output power of each of the first load module 40a, the second load module 40b, the third load module 40c, and the fourth load module 40d according to the future transition of the output electrical powers of the first electrical power generating device 30a and the output electrical power of the second electrical power generating device 30b by acquiring in advance information on the future transition of the output electrical power of the first electrical power generating device 30a and the output electrical power of the second electrical power generating device 30b.

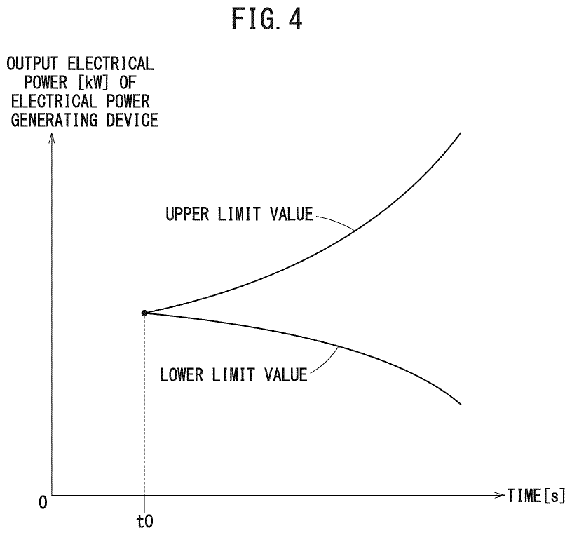

FIG. 4 is a graph illustrating changes over time of an upper limit value and a lower limit value of output electrical power of each of the first electrical power generating device 30a and the second electrical power generating device 30b. As shown in FIG. 4, the management controller 84 estimates the changes over time of the upper limit value and the lower limit value of the output electrical power of each of the first electrical power generating device 30a and the second electrical power generating device 30b, after the current point in time (t0). The management controller 84 transmits information on the changes over time of the upper limit value and the lower limit value of the output electrical power of each of the first electrical power generating device 30a and the second electrical power generating device 30b to the flight controller 86, as the capability information of each of the first electrical power generating device 30a and the second electrical power generating device 30b.

### Upper Limit Value of Input/Output Electrical Power of Electrical Power Storage Device

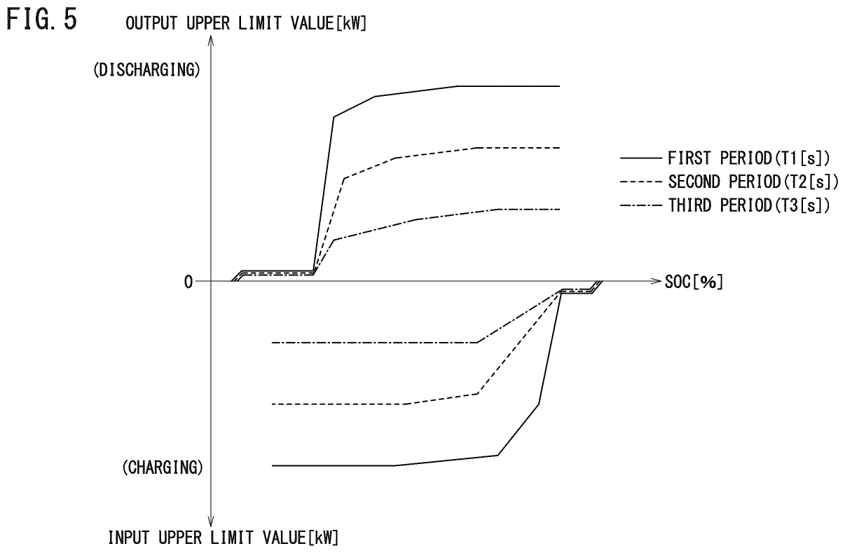

FIG. 5 is a map illustrating an upper limit value of the output electrical power and the upper limit value of the input electrical power of the battery 54 of each of the first electrical power storage device 52a, the second electrical power storage device 52b, the third electrical power storage device 52c, and the fourth electrical power storage device 52d. The map of FIG. 5 illustrates an upper limit value (output upper limit value) that can be continuously output during a first period (T1 [s]) and an upper limit value (input upper limit value) that can be continuously input during the first period (T1 [s]). Also, the map of FIG. 5 illustrates an upper limit value (output upper limit value) that can be continuously output during a second period (T2 [s]) and an upper limit value (input upper limit value) that can be continuously input during the second period (T2 [s]). The map of FIG. 5 illustrates an upper limit value (output upper limit value) that can be continuously output during a third period (T3 [s]) and an upper limit value (input upper limit value) that can be continuously input during the third period (T3 [s]). The length of the second period is greater than the length of the first period. The length of the third period is greater than the length of the second period. As shown in FIG. 5, the upper limit value of the output electrical power and the upper limit value of the input electrical power of the battery 54 change according to the SOC of the battery 54.

The management controller 84 transmits information on the output upper limit value and the input upper limit value of each of the first electrical power storage device 52a, the second electrical power storage device 52b, the third electrical power storage device 52c, and the fourth electrical power storage device 52d in each period corresponding to the SOC of each of the batteries 54 at the current point in time, to the flight controller 86 as the capability information of each of the first electrical power storage device 52a, the second electrical power storage device 52b, the third electrical power storage device 52c, and the fourth electrical power storage device 52d.

The information of the upper limit value that can be output continuously in the first period and the upper limit value that can be input continuously in the first period, with respect to the battery 54 of the first electrical power storage device 52a, corresponds to the first information of the present invention. The information of the upper limit value that can be output continuously in the second period and the upper limit value that can be input continuously in the second period, with respect to the battery 54 of the first electrical power storage device 52a, corresponds to the second information of the present invention. The information of the upper limit value that can be output continuously in the first period and the upper limit value that can be input continuously in the first period, with respect to the battery 54 of the second electrical power storage device 52b, corresponds to the third information of the present invention. The information of the upper limit value that can be output continuously in the second period and the upper limit value that can be input continuously in the second period, with respect to the battery 54 of the second electrical power storage device 52b, corresponds to the fourth information of the present invention.

### About Mediation of Output Power

The flight controller 86 estimates the future output power of each of the first load module 40a, the second load module 40b, the third load module 40c, and the fourth load module 40d, for example, in accordance with the amount of operation of an unillustrated operating element by a pilot. The flight controller 86 also estimates the future required electrical power of each of the first load module 40a, the second load module 40b, the third load module 40c, and the fourth load module 40d from the future output power of each of the first load module 40a, the second load module 40b, the third load module 40c, and the fourth load module 40d.

The flight controller 86 determines whether or not the total of the output electrical powers of the first electrical power generating device 30a, the first electrical power storage device 52a, and the third electrical power storage device 52c in the future is insufficient for the total of the required electrical powers of the first load module 40a and the third load module 40c in the future, based on the capability information of the first electrical power generating device 30a and the capability information of the first electrical power storage device 52a and the third electrical power storage device 52c. Similarly, the flight controller 86 determines whether or not the total of the output electrical powers of the second electrical power generating device 30b, the second electrical power storage device 52b, and the fourth electrical power storage device 52d in the future is insufficient for the total of the required electrical powers of the second load module 40b and the fourth load module 40d in the future, based on the capability information of the second electrical power generating device 30b and the capability information of the second electrical power storage device 52b and the fourth electrical power storage device 52d.

In the case that it is expected that the total of the output electrical powers of the first electrical power generating device 30a, the first electrical power storage device 52a, and the third electrical power storage device 52c will be insufficient, the flight controller 86 limits the output power of each of the first load module 40a and the third load module 40c. Similarly, in the case that it is expected that the total or the output electrical powers of the second electrical power generating device 30b, the second electrical power storage device 52b, and the fourth electrical power storage device 52d will be insufficient, the flight controller 86 limits the output power of each of the second load module 40b and the fourth load module 40d.

In the case it is expected that the total of the output electrical powers of the first electrical power generating device 30a, the first electrical power storage device 52a, and the third electrical power storage device 52c will be insufficient and it is expected that the total of the output electrical powers of the second electrical power generating device 30b, the second electrical power storage device 52b, and the fourth electrical power storage device 52d will not be insufficient, the flight controller 86 increases the output power of each of the second load module 40b and the fourth load module 40d. However, the output power of each of the second load module 40b and the fourth load module 40d is adjusted such that the required electrical powers of the second load module 40b and the fourth load module 40d are equal to or less than the total of the output electrical powers of the second electrical power generating device 30b, the second electrical power storage device 52b, and the fourth electrical power storage device 52d. Thus, the limited output power of each of the first load module 40a and the third load module 40c can be supplemented by the increased output power of each of the second load module 40b and the fourth load module 40d.

Similarly, in the case it is expected that the total of the output electrical powers of the second electrical power generating device 30b, the second electrical power storage device 52b, and the fourth electrical power storage device 52d will be insufficient and it is expected that the total of the output electrical powers of the first electrical power generating device 30a, the first electrical power storage device 52a, and the third electrical power storage device 52c will not be insufficient, the flight controller 86 increases the output power of each of the first load module 40a and the third load module 40c. However, the output power of each of the first load module 40a and the third load module 40c is adjusted such that the required electrical powers of the first load module 40a and the third load module 40c are equal to or less than the total of the output electrical powers of the first electrical power generating device 30a, the first electrical power storage device 52a, and the third electrical power storage device 52c. Thus, the limited output power of each of the second load module 40b and the fourth load module 40d can be supplemented by the increased output power of each of the first load module 40a and the third load module 40c.

### Command Value Determination Control

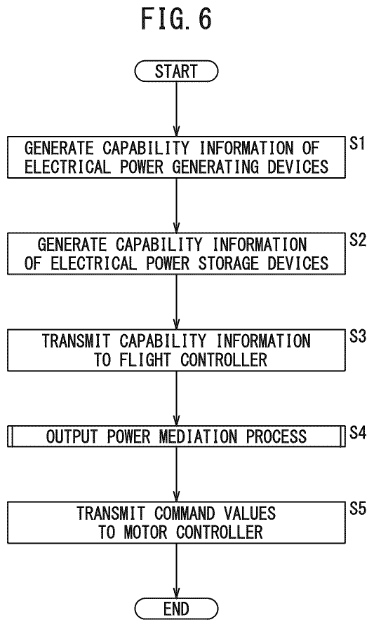

FIG. 6 is a flowchart of a command value determination control executed in the management controller 84 and the flight controller 86.

In step S1, the management controller 84 estimates the changes over time of the upper limit value and the lower limit value of each of the output electrical power of the first electrical power generating device 30a and the output electrical power of the second electrical power generating device 30b, and generates the capability information of each of the first electrical power generating device 30a and the second electrical power generating device 30b. Thereafter, the process transitions to step S2.

In step S2, the management controller 84 generates capability information that is information on the output upper limit value and the input upper limit value of each of the first electrical power storage device 52a, the second electrical power storage device 52b, the third electrical power storage device 52c, and the fourth electrical power storage device 52d for each period, corresponding to the SOC of each of the batteries 54 at the current point in time. Thereafter, the process transitions to step S3.

In step S3, the management controller 84 transmits the capability information of each of the first electrical power generating device 30a and the second electrical power generating device 30b and the capability information of each of the first electrical power storage device 52a, the second electrical power storage device 52b, the third electrical power storage device 52c, and the fourth electrical power storage device 52d to the flight controller 86. Thereafter, the process transitions to step S4.

In step S4, the flight controller 86 executes the output power mediation process. Thereafter, the process transitions to step S5. The output power mediation process will be described in detail later.

In step S5, the flight controller 86 transmits command values for each of the first load module 40a, the second load module 40b, the third load module 40c, and the fourth load module 40d to the motor controller 98. The motor controller 98 controls each of the first load module 40a, the second load module 40b, the third load module 40c, and the fourth load module 40d, based on the command values for each of the first load module 40a, the second load module 40b, the third load module 40c, and the fourth load module 40d. Thereafter, the command value determination control is ended.

### Output Power Mediation Process

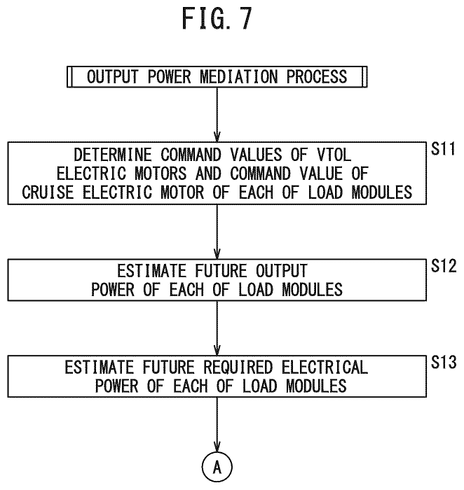

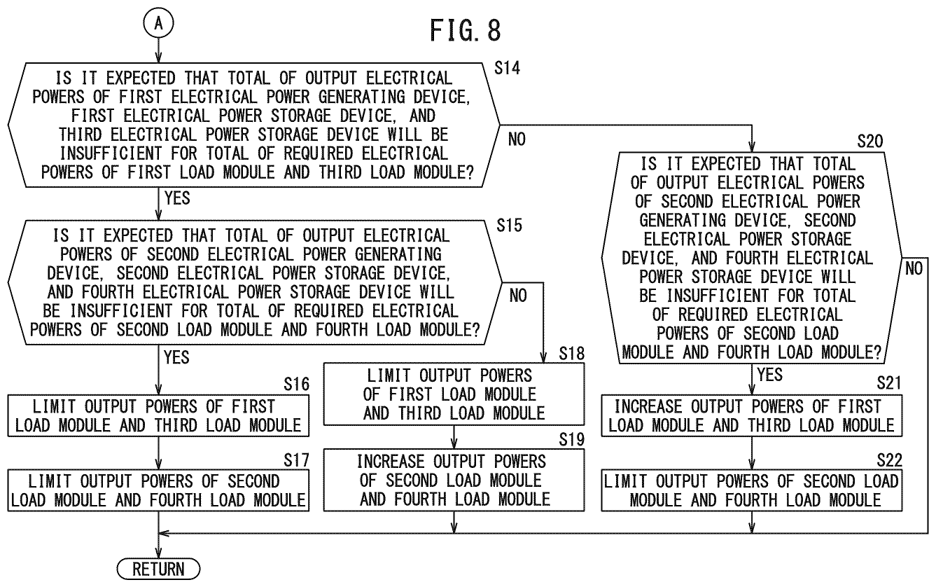

FIGS. 7 and 8 are flowcharts of the output power mediation process in aforementioned step S4.

In step S11, the flight controller 86 determines the command values of the VTOL electric motors 20 and the command value of the cruise electric motor 24 of each of the first load module 40a, the second load module 40b, the third load module 40c, and the fourth load module 40d. The command value of the VTOL electric motor 20 and the command value of the cruise electric motor 24 are determined based on, for example, the amount of operation of an unillustrated operating element by a pilot. Thereafter, the process transitions to step S12.

In step S12, the flight controller 86 estimates the future output power of each of the first load module 40a, the second load module 40b, the third load module 40c, and the fourth load module 40d. Thereafter, the process transitions to step S13.

In step S13, the flight controller 86 estimates the future required electrical power of each of the first load module 40a, the second load module 40b, the third load module 40c, and the fourth load module 40d. Thereafter, the process transitions to step S14.

In step S14, the flight controller 86 determines whether or not it is expected that the total of the output electrical power of the first electrical power generating device 30a, the output electrical power of the first electrical power storage device 52a, and the output electrical power of the third electrical power storage device 52c will be insufficient for the total of the required electrical power of the first load module 40a and the required electrical power of the third load module 40c. In the case that it is determined that the total of the output electrical power of the first electrical power generating device 30a, the output electrical power of the first electrical power storage device 52a, and the output electrical power of the third electrical power storage device 52c is expected to be insufficient (step S14: YES), the process proceeds to step S15. In the case that it is determined that the total of the output electrical power of the first electrical power generating device 30a, the output electrical power of the first electrical power storage device 52a, and the output electrical power of the third electrical power storage device 52c is expected not to be insufficient (step S14: NO), the process proceeds to step $20.

In step S15, the flight controller 86 determines whether or not it is expected that the total of the output electrical power of the second electrical power generating device 30b, the output electrical power of the second electrical power storage device 52b, and the output electrical power of the fourth electrical power storage device 52d will be insufficient for the total of the required electrical power of the second load module 40b and the required electrical power of the fourth load module 40d. In the case that it is determined that the total of the output electrical power of the second electrical power generating device 30b, the output electrical power of the second electrical power storage device 52b, and the output electrical power of the fourth electrical power storage device 52d is expected to be insufficient (step S15: YES), the process proceeds to step S16. In the case that it is determined that the total of the output electrical power of the second electrical power generating device 30b, the output electrical power of the second electrical power storage device 52b, and the output electrical power of the fourth electrical power storage device 52d is expected not to be insufficient (step S15: NO), the process proceeds to step S18.

In step S16, the flight controller 86 corrects the command values of the VTOL electric motors 20 and the command value of the cruise electric motor 24 of each of the first load module 40a and the third load module 40c so as to limit the output power of the first load module 40a and the output power of the third load module 40c. Thereafter, the process transitions to step S17.

In step S17, the flight controller 86 corrects the command values of the VTOL electric motors 20 and the command value of the cruise electric motor 24 of each of the second load module 40b and the fourth load module 40d so as to limit the output power of the second load module 40b and the output power of the fourth load module 40d. Then, the output power mediation process is ended.

As described above, in step S15, in the case that it is determined that the total of the output electrical power of the second electrical power generating device 30b, the output electrical power of the second electrical power storage device 52b, and the output electrical power of the fourth electrical power storage device 52d is expected not to be insufficient (step S15: NO), the process proceeds to step S18.

In step S18, the flight controller 86 corrects the command values of the VTOL electric motors 20 and the command value of the cruise electric motor 24 of each of the first load module 40a and the third load module 40c so as to limit the output power of the first load module 40a and the output power of the third load module 40c. Thereafter, the process transitions to step S19.

In step S19, the flight controller 86 corrects the command values of the VTOL electric motors 20 and the command value of the cruise electric motor 24 of each of the second load module 40b and the fourth load module 40d so as to increase the output power of the second load module 40b and the output power of the fourth load module 40d. Then, the output power mediation process is ended.

As described above, in step S14, in the case that it is determined that the total of the output electrical power of the first electrical power generating device 30a, the output electrical power of the first electrical power storage device 52a, and the output electrical power of the third electrical power storage device 52c is expected not to be insufficient (step S14: NO), the process proceeds to step S20.

In step S20, the flight controller 86 determines whether or not it is expected that the total of the output electrical power of the second electrical power generating device 30b, the output electrical power of the second electrical power storage device 52b, and the output electrical power of the fourth electrical power storage device 52d will be insufficient for the total of the required electrical power of the second load module 40b and the required electrical power of the fourth load module 40d. In the case that it is determined that the total of the output electrical power of the second electrical power generating device 30b, the output electrical power of the second electrical power storage device 52b, and the output electrical power of the fourth electrical power storage device 52d is expected to be insufficient (step S20: YES), the process proceeds to step S21. In the case that it is determined that the total of the output electrical power of the second electrical power generating device 30b, the output electrical power of the second electrical power storage device 52b, and the output electrical power of the fourth electrical power storage device 52d is expected not to be insufficient (step S20: NO), the output power mediation process is ended.

In step S21, the flight controller 86 corrects the command values of the VTOL electric motors 20 and the command value of the cruise electric motor 24 of each of the first load module 40a and the third load module 40c so as to increase the output power of the first load module 40a and the output power of the third load module 40c. Thereafter, the process transitions to step S22.

In step S22, the flight controller 86 corrects the command values of the VTOL electric motors 20 and the command value of the cruise electric motor 24 of each of the second load module 40b and the fourth load module 40d so as to limit the output power of the second load module 40b and the output power of the fourth load module 40d. Then, the output power mediation process is ended.

The following supplementary notes are further disclosed in relation to the above-described embodiments.

### Supplementary Note 1

The electrical power supply system (26) according to the present disclosure includes the first generator (34) configured to be driven by the first gas turbine engine (32) to generate electrical power, the first power control unit (36) configured to convert the alternating current electrical power output from the first generator into the direct current electrical power, the first electrical power supply circuit (38a) configured to supply the output electrical power of the first power control unit to the first load device, the first battery (54) connected in parallel with the first power control unit, the load controller (86) configured to control the first load device, and the battery controller (94) configured to manage the first battery, wherein the battery controller provides the load controller with capability information including first information and second information, the first information indicating the upper limit of electrical power that is capable of being input and output by the first battery continuously for the first period, the second information indicating the upper limit of electrical power that is capable of being input and output by the first battery continuously for the second period longer than the first period, and the load controller controls the first load device, based on the capability information provided by the battery controller.

### Supplementary Note 2

In the electrical power supply system according to Supplementary Note 1, the capability information may include the information on the transition of the output electrical power of the first power control unit.

### Supplementary Note 3

The electrical power supply system according to Supplementary Note 1, may further include the second generator (34) configured to be driven by the second gas turbine engine (32) to generate electrical power, the second power control unit (36) configured to convert the alternating current electrical power output from the second generator into the direct current electrical power, the second electrical power supply circuit (38b) configured to supply the output electrical power of the second power control unit to the second load device, and the second battery (54) connected in parallel with the second power control unit, wherein the load controller may control the second load device, the battery controller may manage the second battery, the capability information may include third information and fourth information, the third information indicating an upper limit of electrical power that is capable of being input and output by the second battery continuously for the first period, the fourth information indicating an upper limit of electrical power that is capable of being input and output by the second battery continuously for the second period, and in the case it is expected that the total of the output electrical power of the first power control unit and the output electrical power of the first battery is insufficient for the required electrical power of the first load device and it is expected that the total of the output electrical power of the second power control unit and the output electrical power the second battery is not insufficient for the required electrical power of the second load device, the output power of the first load device may be limited and the output power of the second load device may be increased.

### Supplementary Note 4

The moving object (10) according to the present disclosure includes the electrical power supply system according to any one of Supplementary Notes 1 to 3.

### Supplementary Note 5

In the method of controlling the electrical power supply system according to the present disclosure, the electrical power supply system includes the first generator configured to be driven by the first gas turbine engine to generate electrical power, the first power control unit configured to convert the alternating current electrical power output from the first generator into the direct current electrical power, the first electrical power supply circuit configured to supply the output electrical power of the first power control unit to the first load device, the first battery connected in parallel with the first power control unit, the load controller configured to control the first load device, and the battery controller configured to manage the first battery, and the method includes providing the load controller with capability information including first information and second information, from the battery controller, the first information indicating the upper limit of electrical power that is capable of being input and output by the first battery continuously for the first period, the second information indicating the upper limit of electrical power that is capable of being input and output by the first battery continuously for the second period longer than the first period, and controlling the first load device by the load controller, based on the capability information provided from the battery controller.

### Supplementary Note 6

In the method of controlling the electrical power supply system according to Supplementary Note 5, the capability information may include the information on the transition of the output electrical power of the first power control unit.

While the present disclosure has been described in detail, the present disclosure is not limited to the individual embodiments described above. Within a range that does not depart from the essence and gist of the present disclosure, or within a range that does not depart from the gist and essence of the present disclosure derived from the content described in the claims and equivalents thereof, various additions, substitutions, changes, partial deletions, or the like can be made to such embodiments. These embodiments may also be implemented in combination. For example, in the embodiments described above, the order of the operations and the order of the processes are shown as examples, and the present invention is not limited to such operations and processes. The same applies to the case where numerical values or mathematical expressions are used in the description of the above-described embodiments.

1. An electrical power supply system comprising:
a first generator configured to be driven by a first gas turbine engine to generate electrical power;
a first power control unit configured to convert an alternating current electrical power output from the first generator into a direct current electrical power;
a first electrical power supply circuit configured to supply an output electrical power of the first power control unit to a first load device;
a first battery connected in parallel with the first power control unit;
a load controller including one or more first processors that execute computer-executable instructions stored in a memory, the one or more first processors executing the computer-executable instructions to cause the load controller to control the first load device; and
a battery controller including one or more second processors that execute computer-executable instructions stored in a memory, the one or more second processors executing the computer-executable instructions to cause the battery controller to manage the first battery,
wherein the one or more second processors execute the computer-executable instructions to cause the battery controller to provide the load controller with capability information including first information and second information, the first information indicating an upper limit of electrical power that is capable of being input and output by the first battery continuously for a first period, the second information indicating an upper limit of electrical power that is capable of being input and output by the first battery continuously for a second period longer than the first period, and
the one or more first processors execute the computer-executable instructions to cause the load controller to control the first load device, based on the capability information provided by the battery controller.

2. The electrical power supply system according to claim 1, wherein the capability information includes information on a transition of the output electrical power of the first power control unit.

3. The electrical power supply system according to claim 1, further comprising:
a second generator configured to be driven by a second gas turbine engine to generate electrical power;
a second power control unit configured to convert an alternating current electrical power output from the second generator into a direct current electrical power;
a second electrical power supply circuit configured to supply an output electrical power of the second power control unit to a second load device; and
a second battery connected in parallel with the second power control unit,
wherein the one or more first processors execute the computer-executable instructions to cause the load controller to control the second load device,
the one or more second processors execute the computer-executable instructions to cause the battery controller to manage the second battery,
the capability information includes third information and fourth information, the third information indicating an upper limit of electrical power that is capable of being input and output by the second battery continuously for the first period, the fourth information indicating an upper limit of electrical power that is capable of being input and output by the second battery continuously for the second period, and
in a case it is expected that a total of the output electrical power of the first power control unit and the output electrical power of the first battery is insufficient for a required electrical power of the first load device and it is expected that a total of the output electrical power of the second power control unit and the output electrical power the second battery is not insufficient for a required electrical power of the second load device, an output power of the first load device is limited and an output power of the second load device is increased.

4. A moving object comprising the electrical power supply system according to claim 1.

5. A method of controlling an electrical power supply system including:
a first generator configured to be driven by a first gas turbine engine to generate electrical power;
a first power control unit configured to convert an alternating current electrical power output from the first generator into a direct current electrical power;
a first electrical power supply circuit configured to supply an output electrical power of the first power control unit to a first load device;
a first battery connected in parallel with the first power control unit;
a load controller configured to control the first load device; and
a battery controller configured to manage the first battery,
the method comprising:
providing the load controller with capability information including first information and second information, from the battery controller, the first information indicating an upper limit of electrical power that is capable of being input and output by the first battery continuously for a first period, the second information indicating an upper limit of electrical power that is capable of being input and output by the first battery continuously for a second period longer than the first period, and
controlling the first load device by the load controller, based on the capability information provided from the battery controller.

6. The method of controlling the electrical power supply system according to claim 5, wherein the capability information includes information on a transition of the output electrical power of the first power control unit.
